(19) United States
(12) Patent Application Publication
(10) Pub. No.: US 2017/0103351 A1
(43) Pub. Date: Apr. 13, 2017

(54) SYSTEMS AND METHODS FOR PROVIDING AND MANIPULATING TRAVEL INFORMATION

(71) Applicant: Ooola Travel Inc., Vancouver (CA)

(72) Inventor: Yu Ji Zhang, Coquitlam (CA)

(73) Assignee: Ooola Travel Inc., Vancouver (CA)

(21) Appl. No.: 15/286,370

(22) Filed: Oct. 5, 2016

Related U.S. Application Data
(60) Provisional application No. 62/238,492, filed on Oct. 7, 2015.

(51) Int. Cl. G06Q 10/02

(52) U.S. Cl. CPC G06Q 10/025

(57) ABSTRACT

Methods and systems for identifying travel itineraries are described herein. The system includes one or more databases storing traveller types, travel itineraries associated with a traveller type, and images associated with a traveller type. The system identifies images and makes them available for selection. Upon selection of an image, the system determines the traveller type associated with the selected image and based on the determined traveller type, identifies matching travel itineraries. These travel itineraries are returned in response to the selection of the image.

### CROSS REFERENCE TO RELATED APPLICATION

This application claims the benefit of U.S. Provisional Patent Application No. 62/238,492, filed on Oct. 7, 2015, the entirety of which is hereby incorporated by reference.

### FIELD OF THE DISCLOSURE

The present disclosure relates generally to travel systems and methods, and specifically to systems and methods of providing and manipulating travel information.

### BACKGROUND

Web servers providing travel booking functionality typically operate by allowing potential travellers the option to select their desired itineraries based on travel dates, geographical characteristics (e.g., a country, city, or region), and/or available activities.

In selecting the aspects of their itineraries, travellers may base their selections on reviews, promotional materials, or recommendations from friends, family, or travel agents to help them decide how their trip should be structured. However, these types of information are often external to the traveller and may not accurately reflect whether the traveller will actually enjoy the itinerary they selected. This is because individuals may have different travel preferences, and what may be enjoyable or suitable for one traveller may not be so for another.

Some organizations have conducted research to identify various traveller types, which are useful for providing a better indication of the nature of travel activities that a traveler of a given traveller type would enjoy. For example, one set of traveller types is the Explorer Quotient™ (EQ) type published by the Canadian Tourism Commission. However, existing mechanisms for a traveller to identify his or her traveller type typically require the traveller to complete online surveys, so as to make it difficult for the traveller to know his or her traveller type when booking a travel itinerary.

There is thus a need for improved systems and methods for providing and manipulating travel information.

### SUMMARY

The following embodiments and aspects thereof are described and illustrated in conjunction with systems and methods which are meant to be exemplary and illustrate, not limiting in scope.

One aspect of the invention provides a system for identifying travel itineraries. The system includes one or more databases storing a plurality of traveller types; a plurality of travel itineraries, wherein each of the plurality of travel itineraries is associated with at least one of the plurality of traveller types; and a plurality of images, wherein each of the plurality of images is associated with at least one of the plurality of traveller types. The system also includes a processor configured to: identify a subset of the plurality of images; receive input selecting an image of the subset of images; determine, from the one or more databases, the at least one traveller type associated with the selected image; identify, from the one or more databases, a subset of the plurality of travel itineraries that are associated with the determined at least one traveller type; and provide the subset of the plurality of travel itineraries, in response to the received input selecting the one image of the subset of images.

In some embodiments, the plurality of traveller types correspond to psychographic classifications. In some embodiments, the psychographic classifications include Explorer Quotient™ profile types.

In some embodiments, the one or more databases store information for a plurality of inventory offerings, and wherein the processor is further configured to receive input selecting an inventory offering from the plurality of inventory offerings for association with a travel itinerary of the plurality of travel itineraries.

In some embodiments, each of the inventory offerings is associated with one or more traveller types of the plurality of traveller types. In some embodiments, the one or more traveller types associated with the inventory offerings are available to be accessed prior to the processor receiving input for selecting an inventory offering to be associated with a travel itinerary. In some embodiments, a number of inventory offerings are selected to be associated with a given travel itinerary, and the at least one traveller type associated with the given travel itinerary is determined from the traveller types associated with the number of inventory offerings. In some embodiments, the at least one traveller type associated with a given travel itinerary is pre-determined, and only a subset of the plurality of inventory offerings that are associated with the pre-determined at least one traveller type are available to be selected for association with the given travel itinerary.

In some embodiments, the associations between the plurality of images and their respective traveller types are pre-determined and loaded into the one or more databases.

In some embodiments, the associations between the plurality of images and their respective traveller types are generated from an electronic survey. In some embodiments, the processor is further configured to conduct the electronic survey by making available for display an uncategorized image that has not been associated with any traveller type; providing one or more of the plurality of traveller types as options to be selected to be associated with the uncategorized image; receiving input selecting a traveller type of the one or more of the plurality of traveller types as being associated with the uncategorized image; and storing an association between the selected traveller type and the uncategorized image in the one or more databases.

In some embodiments, the subset of the plurality of images is transmitted to a client device for display, and wherein the input selecting the image of the subset of images is received from the client device.

In some embodiments, the processor is further configured to receive input, from a first traveller device; selecting one itinerary of the subset of the plurality of itineraries, the one itinerary including a plurality of inventory offerings, each of which is associated with a geographical location; in response to the received input selecting the one itinerary, provide an itinerary identifier for identifying the selected itinerary, wherein the itinerary identifier is transmittable to a second traveller device; receive input, from the second traveller device, including the itinerary identifier for the selected itinerary and a request to modify an inventory offering of the selected itinerary; and provide an alternate inventory offering for the inventory offering requested to be modified, the alternate inventory offering being associated with the geographical location of the activity requested to be modified.

In some embodiments, the processor is further configured to receive input from the second traveller device selecting the alternate inventory offering, and create a new itinerary including the alternate inventory offering and the plurality of inventory offerings associated with the one selected itinerary except the inventory offering requested to be modified.

In some embodiments, the processor is further configured to receive input from the second traveller device selecting the alternate inventory offering, and create a new itinerary including the alternate inventory offering and a link to the one selected itinerary.

In some embodiments, each of the plurality of images is associated with a textual description, and the textual description accompanies the subset of the plurality of images when the subset of plurality of images is identified.

Another aspect of the invention provides a method of identifying travel itineraries at a server, the method includes the steps of: identifying a plurality of images stored in one or more databases, each of the plurality of images associated with at least one of a plurality of traveller types; identifying a subset of the plurality of images; receiving input selecting an image of the subset of images; determining, from the one or more databases, the at least one traveller type associated with the selected image; identifying, from the one or more databases storing a plurality of travel itineraries, each of which is associated with at least one of the plurality of traveller types, a subset of the plurality of travel itineraries that are associated with the determined at least one traveller type; and providing the subset of the plurality of travel itineraries, in response to the received input selecting the one image of the subset of images.

In some embodiments, the plurality of traveller types corresponds to psychographic classifications. In some embodiments, the psychographic classifications include Explorer Quotient™ profile types.

In some embodiments, the method includes the step of receiving input selecting an inventory offering from a plurality of the inventory offerings stored on the one or more databases for association with a travel itinerary of the plurality of travel itineraries.

In some embodiments, the inventory offerings are each associated with one or more traveller types of the plurality of traveller types. In some embodiments, the one or more traveller types associated with the inventory offerings are available to be accessed prior to the step of receiving input for selecting an inventory offering to be associated with a travel itinerary. In some embodiments, a number of inventory offerings are selected to be associated with a given travel itinerary, and the at least one traveller type associated with the given travel itinerary is determined from the traveller types associated with the number of inventory offerings. In some embodiments, the at least one traveller type associated with a given travel itinerary is pre-determined, and only a subset of the plurality of inventory offerings, each of which is associated with the pre-determined at least one traveller type, are available to be selected for association with the given travel itinerary.

In some embodiments, the associations between the plurality of images and their respective traveller types are pre-determined and loaded into the one or more databases.

In some embodiments, the associations between the plurality of images and their respective traveller types are generated from an electronic survey. In some embodiments, the step of conducting the electronic survey is performed by: making available for display an uncategorized image that has not been associated with any traveller type; providing one or more of the plurality of traveller types as options to be selected to be associated with the uncategorized image; receiving input selecting a traveller type of the one or more of the plurality of traveller types as being associated with the uncategorized image; and storing an association between the selected traveller type and the uncategorized image in the one or more databases.

In some embodiments, the subset of the plurality of images is transmitted to a client device for display, and wherein the input selecting the image of the subset of images is received from the client device.

In some embodiments, the method includes the steps of: receiving input, from a first traveller device, selecting one itinerary of the subset of the plurality of itineraries, the one itinerary including a plurality of inventory offerings that are each associated with a geographical location; in response to the received input selecting the one itinerary, providing an itinerary identifier for identifying the selected itinerary, wherein the itinerary identifier is transmittable to a second traveller device; receiving input, from the second traveller device, including the itinerary identifier for the selected itinerary and a request to modify an inventory offering of the selected itinerary; and providing an alternate inventory offering for the inventory offering requested to be modified, the alternate inventory offering being associated with the geographical location of the activity requested to be modified.

In some embodiments, the method includes receiving input from the second traveller device selecting the alternate inventory offering, and creating a new itinerary including the alternate inventory offering, and the plurality of inventory offerings associated with the one selected itinerary except the inventory offering requested to be modified.

In some embodiments, the method includes receiving input from the second traveller device selecting the alternate inventory offering, and creating a new itinerary including the alternate inventory offering and a link to the one selected itinerary.

In some embodiments, each of the plurality of images is associated with a textual description, and the textual description accompanies the subset of the plurality of images when the subset of plurality of images is identified.

In some embodiments, the methods are performed by a processor.

Another aspect of the invention provides a computer-readable medium storing instructions which, when executed by a processor of a computing device, causes the processor to perform the methods noted above.

### BRIEF DESCRIPTION OF THE DRAWINGS

Non-limiting examples of various embodiments of the present disclosure will next be described in relation to the drawings, in which:

FIG. 1 is a block diagram of a system for providing and manipulating travel information, in accordance with an embodiment of the present disclosure;

FIG. 2 is a flow chart diagram illustrating steps for providing a travel itinerary, in accordance with an embodiment of the present disclosure;

FIG. 3 is an example user interface for potential travellers to search for travel itineraries, in accordance with an embodiment of the present disclosure;

FIG. 4 is an example user interface for displaying details of a travel itinerary, in accordance with an embodiment of the present disclosure;

FIG. 5 is an example user interface showing a summary view of a travel itinerary, in accordance with an embodiment of the present disclosure;

FIG. 6 is a flow chart diagram illustrating steps for manipulating a travel itinerary, in accordance with an embodiment of the present disclosure;

FIG. 7 is an example user interface presented to a potential traveller for verifying their ability to modify an itinerary that has been shared with them, in accordance with an embodiment of the present disclosure;

FIG. 8 is an example user interface for modifying an inventory offering of a shared itinerary, in accordance with an embodiment of the present disclosure;

FIG. 9 is an example user interface for creating an itinerary, in accordance with an embodiment of the present disclosure;

FIGS. 10 and 11 are example user interfaces for organizing created travel itineraries, in accordance with embodiments of the present disclosure;

FIGS. 12 to 17 are example user interfaces for inserting information about inventory offerings that may be added to a travel itinerary, in accordance with embodiments of the present disclosure;

FIGS. 18 to 19 are example user interfaces for organizing inventory offerings that may be associated with a travel itinerary, in accordance with embodiments of the present disclosure;

FIG. 20 is another example user interface for potential travellers to search for travel itineraries, in accordance with another embodiment of the present disclosure; and

FIG. 21 is another example user interface showing a summary view of a travel itinerary, in accordance with another embodiment of the present disclosure.

In addition to the exemplary aspects and embodiments described above, further aspects and embodiments will become apparent by reference to the drawings and by study of the following detailed description.

### DETAILED DESCRIPTION

For simplicity and clarity of illustration, where considered appropriate, reference numerals may be repeated among the figures to indicate corresponding or analogous elements or steps. In addition, numerous specific details are set forth in order to provide a thorough understanding of the exemplary embodiments described herein. However, it will be understood by those of ordinary skill in the art that the embodiments described herein may be practiced without these specific details. In other instances, certain steps, signals, protocols, software, hardware, networking infrastructure, circuits, structures, techniques, well-known methods, procedures and components have not been described or shown in detail in order not to obscure the embodiments generally described herein.

Furthermore, this description is not to be considered as limiting the scope of the embodiments described herein in any way. It should be understood that the detailed description, while indicating specific embodiments, are given by way of illustration only, since various changes and modifications within the scope of the disclosure will become apparent to those skilled in the art from this detailed description.

The embodiments of the methods described herein may be implemented in hardware or software, or a combination of both. In some cases, embodiments may be implemented in one or more computer programs executing on one or more programmable computing devices (e.g., the various devices and servers discussed below) including at least one processor (e.g., a microprocessor), a data storage device (including in some cases volatile and non-volatile memory and/or data storage elements), at least one communications interface (e.g., a network interface card for wired or wireless network communications), at least one input device, and at least one output device. For example and without limitation, the programmable computing devices may be a personal computer, laptop, personal data assistant, cellular telephone, smartphone device, tablet computer, smartwatch, and/or wireless device. Additional examples of programmable computing devices are also discussed below. Program code is applied to input data to perform the functions described herein and generate output information. The output information is applied to one or more output devices.

Those of skill in the art will understand that the following description of illustrative embodiments of the disclosure does not limit the implementation of embodiments of the disclosure to any particular computer programming language. For example, in some embodiments, each program, module, or application may be implemented in a high level procedural or object oriented programming and/or scripting language to communicate with a computer system. However, the programs can be implemented in assembly or machine language, if desired. In any case, the language may be a compiled or interpreted language.

More specifically, embodiments of the disclosure may be implemented in any computer programming language provided that the operating system (O/S) provides the facilities that may support the present disclosure. For instance, an embodiment of the present disclosure may be implemented in part in the JAVA™ computer programming language (or other computer programming languages such as C or C++), but the web-related components of the present disclosure may more commonly be implemented using scripting languages typical for web develop environments (e.g., JavaScript for client-side applications and PHP/Python/Perl for server-side applications). Those skilled in the art will also appreciate that any limitations presented by such an embodiment would be a result of a particular type of operating system or computer programming/scripting language and would not be a limitation of the present disclosure.

In some embodiments, the computing devices and methods as described herein may also be implemented as a transitory or non-transitory computer-readable storage medium configured with a computer program, wherein the storage medium so configured causes a computing device to operate in a specific and predefined manner to perform at least some of the functions as described herein. The medium may be provided in various forms, including one or more diskettes, compact disks, tapes, chips, wireline transmissions, satellite transmissions, internet transmission or downloadings, magnetic and electronic storage media, digital and analog signals, and the like. The computer usable instructions may also be in various forms, including compiled, non-compiled, bytecode, or other forms in which the instructions may be interpreted or translated.

Moreover, the subject system may be implemented as one or more software components stored on one or more computer servers that are accessible via one or more client machines in a client-server architecture. In such case, the system can be considered to be a hosted software offering or a software service in a software-as-a-service deployment.

Additional aspects and advantages of the present disclosure will be apparent in view of the description which follows.

### Overview

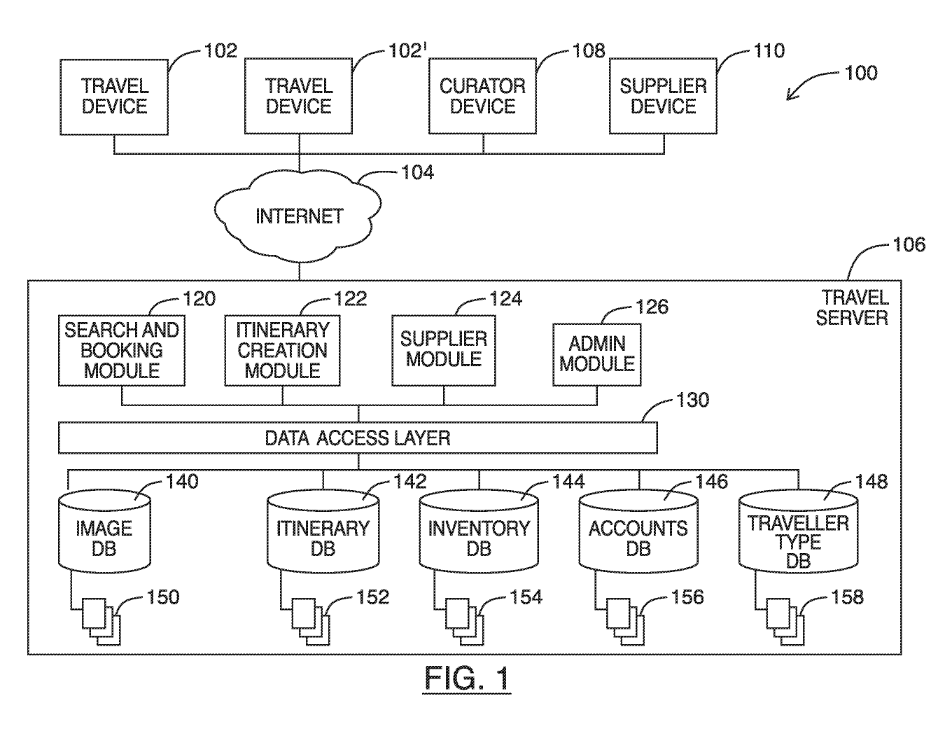

Referring to FIG. 1, shown there generally as 100 is a block diagram for a system for providing and manipulating travel information, in accordance with an embodiment of the present disclosure. The system 100 may include one or more travel devices 102, 102′, a curator device 108, and a supplier device 110, each in communication with a travel server 106, for example via a communications network such as the Internet 104. In operation, the travel server 106 may be configured to communicate with the travel devices 102, 102′ over the Internet 104 to allow searching, identifying, and booking travel itineraries. As used herein, the term “traveller device” or “client device” may also refer to the travel devices 102, 102′.

The travel devices 102, 102′, curator device 108, and supplier device 110 may be various programmable computing devices (examples of which were noted above) that are configured to access the travel server 106 to perform tasks with respect to travel information. In various embodiments, the applications executing on these devices may be a thick or thin client which accesses Application Programming Interfaces (APIs) available on the travel server 106. Additionally or alternatively, the applications on these devices accessing the travel server 106 may be a web browser configured to access a web server that is providing access to travel information on the travel server 106. Other ways of communicating with the travel server 106 may also be possible.

Internet 104 is illustrated in FIG. 1 as an example of a communications network that may facilitate communications amongst the travel devices 102, 102′, curator device 108, supplier device 110, and the travel server 106. However, it will be understood that other communications networks may also be possible. For example, the communication of messages described in the current disclosure may be performed (either wholly or partially) through proprietary or private networks, or cellular networks.

Travel server 106 may be a computing device configured to execute server applications that allow travel devices 102, 102′ to access travel itinerary information. In various example embodiments, the travel server 106 may be provided on a dedicated server computer, mainframe, computer cluster, or like computing resource. The travel server 106 may be configured to allow one or more of travel devices 102, 102′, curator device 108, and supplier device 110 access to the itinerary information via any suitable means of computer communications. For example, access to the itinerary information may be provided in the form of a customized API or as a web interface. In some embodiments, travel server 106 includes a Microsoft™ SQL Server™ database server and a Microsoft™ Internet Information Services (IIS)™ web server, and functionalities of travel server 106 are implemented using the Microsoft™ .NET framework.

The travel server 106 may include server applications/modules that allow travel devices 102, 102′ to access to travel itinerary information, including a search and booking module 120, an itinerary creation module 122, a supplier module 124, and an administration module 126. Each of these modules may be configured to communicate with a data access layer 130, which provides access to data related to travel itineraries. For example, such data may be stored in an image database 140 storing images 150 that may be associated with traveller types 158 (as discussed further below); an itinerary database 142 storing itinerary data 152 such as particular activities or locations that travellers may be viewing or looking to partake in; an inventory database 144 storing inventory offerings 154 that may be added to itineraries (as used herein, the term “inventory offering” refers to any type of product or service that may be added to an itinerary, including, for example, accommodation, travel, food, entertainment, culture, shopping, transport, physical activity information, and the like); an accounts database 146 storing account information 156 for users of the system 100; and a traveller type database 148 storing traveller types 158.

These different components of travel server 106 will now be discussed in greater detail.

The traveller type database 148 may be populated with traveller types 158 according to traveller types as created by different organizations. In some embodiments, traveller types may correspond to psychographic classifications of potential travellers based on the personality, values, opinions, attitudes, interest and style traits of the individual. Psychographic analysis of the pool of potential travellers may provide enhanced insight into a potential traveller by categorizing the individual based on factors that are more likely to be predictive of whether the individual will enjoy a given itinerary 152 or inventory offering 154. In some embodiments, one set of traveller types that may be used in the system of the present disclosure is the Canadian Tourism Commission's Explorer Quotient™ (EQ) traveller types, which contain the following nine traveller types: Cultural Explorer, Cultural History Buff, Free Spirit, Gentle Explorer, No-hassle Traveller, Personal History Explorer, Rejuvenator, Virtual Traveller, and Authentic Experiencer. Additional information about the EQ Types can be found at the following hyperlink (http://quiz.canada.travel/caen/all-traveller-types), the entire contents of which are hereby incorporated by reference. In some embodiments, all nine traveller types are implemented as traveller types 158 in traveller type database 148. In some embodiments, only some of the nine traveller types are implemented as traveller types 158 in traveller type database 148.

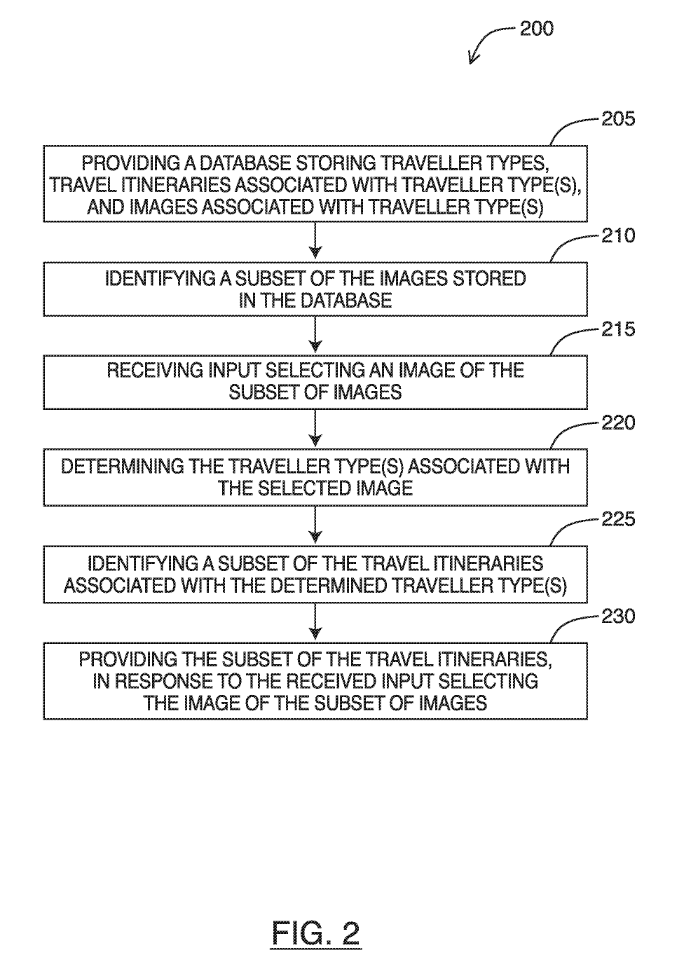

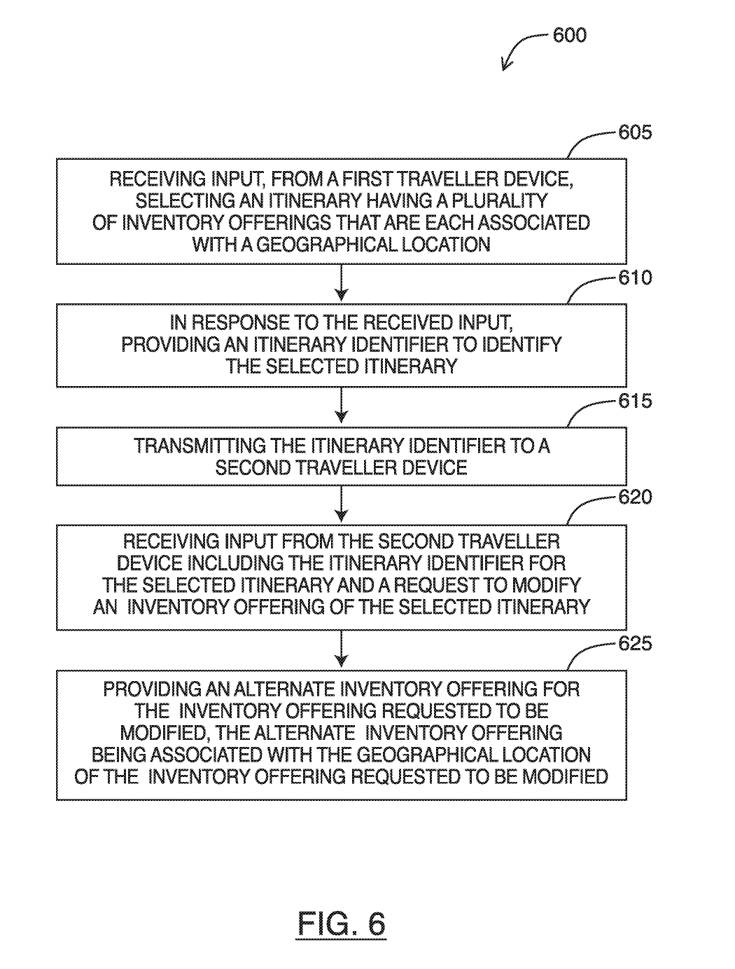

The search and booking module 120 may be accessed by potential travellers using travel devices 102, 102′. The search and booking module 120 may be configured to provide software functionality that allows potential travellers to search for and identify travel itineraries suitable to their traveller type 158. As described in greater detail below with respect to FIGS. 2-5, the search and booking module 120 may be configured to present images 150 that correspond to traveller types 158, so that potential travellers can select a particular image 150. Once selected, the traveller type 158 corresponding to the selected image can be used in a search query into the itinerary database 142 to identify travel itineraries 152 that are associated with the traveller type 158. In some embodiments, the search and booking module 120 may allow the selected travel itineraries 152 to be customized by the potential traveller and/or shared by a user with other potential travellers. As described in greater detail below with respect to FIGS. 6-8, in some embodiments, the search and booking module 120 may also be accessed by potential travellers with whom an itinerary 152 has been shared, to modify the shared itinerary 152.

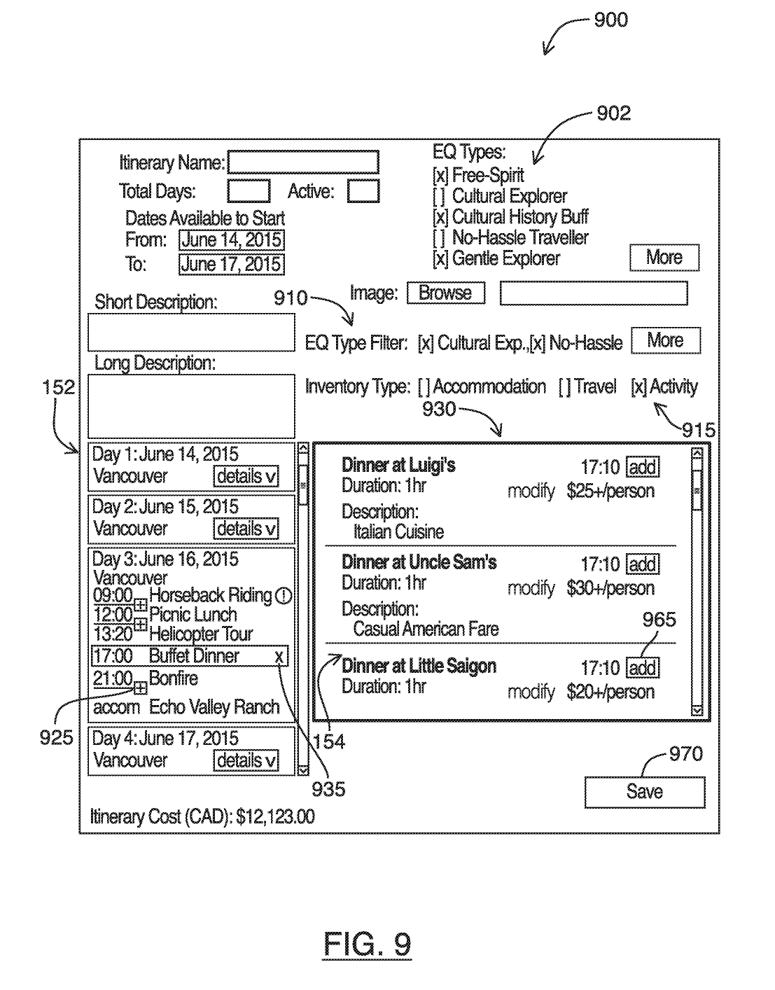

In some embodiments, the itinerary creation module 122 may be accessed by individuals (called “curators” herein) familiar with the travel inventory offerings 154 and traveller types 158 using curator device 108, to create itineraries that are suitable for travellers of a given traveller type 158. As discussed in greater detail below with respect to FIGS. 9-11, the itinerary creation module 122 may be configured to allow searching of the inventory database 144 for appropriate inventory offerings 154 that can be added to a given travel itinerary 152. In some embodiments, itineraries 154 created by curators may be associated with different traveller types 158, so that suitable itineraries may be returned for display when searched by potential travellers using the search and booking module 120.

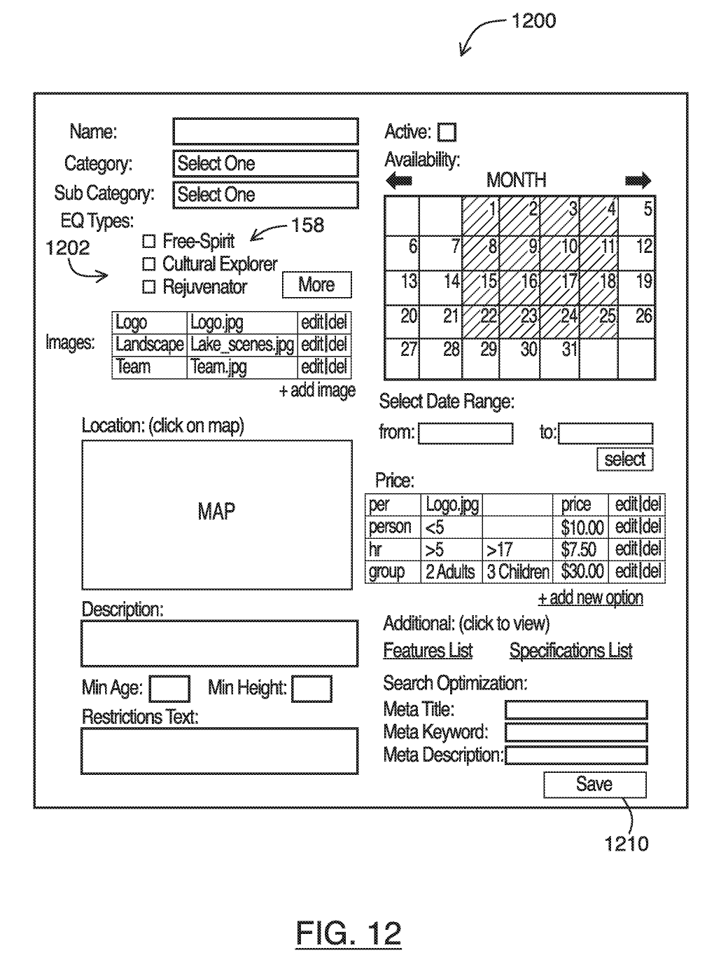

The supplier module 124 may be accessed by individuals using supplier device 110 who upload inventory offerings 154 to the travel server 106. For example, such individuals may be accommodation providers (e.g., hotel chain owners or owners of bed & breakfasts) or tour operators (e.g., tour guides or boat cruise operators) who would like their offerings to be available to be added to itineraries 152 or booked on travel server 106. As discussed in greater detail below with respect to FIGS. 12-19, when adding inventory offerings, the supplier may be able to indicate that their particular inventory offering is associated with a traveller type 158. This may allow curators using the itinerary creation module 122 to better identify certain inventory offerings 154 for inclusion into itineraries 152 that are designed for particular traveller types 158. As discussed below with respect to FIGS. 6-8, the association of inventory offerings 154 to traveller types 158 may also allow for the identification of alternate inventory offerings 154 that satisfy the traveller type 158 of a second potential traveller with whom an itinerary has been shared, who happens not to be of the same traveller type 158 as the first potential traveller who created the travel itinerary.

The admin module 126 may allow access to functionality related to the creating, editing, and modification of user accounts and profiles of users of the system 100. For example, different accounts for potential travellers, curators, or suppliers may be created for users using travel devices 102, 102′, curator devices 108, or supplier devices 110 respectively. The account information 156 (e.g., usernames, passwords, security questions, preferences) for various users may be stored in accounts database 146.

In various embodiments, a given potential traveller account may be associated with a traveller type 158, and that information may be included in the account information 156 stored in accounts database 146 for that user. The traveller type 158 of a given potential traveller may be inputted as account information 156 in various ways. For example, an account creation user interface provided by admin module 126 may have an option that allows the potential traveller to select their particular traveller type 158. Additionally or alternatively, the user interface may provide access to a questionnaire (e.g., as may be provided by the Canadian Tourism Commission for EQ Types™) that allows the user to determine their traveller type(s) 158.

In some embodiments, a further option for identifying a traveller type 158 associated with potential traveller user is for the admin module 126 to determine the traveller type 158 from historical information about how the user has selected images 150 from the image database 140. As noted, when accessing the search and booking module 120 to search for and book itineraries 152, the potential traveller user may be presented with images 150 that are associated with traveller types 158. In various embodiments, upon a selection of an image, the search and booking module 120 may be configured to store the image selection information for a potential traveller in the account information 156 for that user. Over a period of time, a given user may have a number of image selections. The admin module 126 may then determine the traveller type 158 of the user by the traveller type 158 that is most commonly occurring in the images selected by the user over a period of time.

While the various modules 120, 122, 124, 126 are illustrated and discussed herein as separate modules, it will be appreciated that in alternate embodiments, the functionality provided by the different modules may be combined together into one or more modules or further separated in more than the described four modules, depending on the nature of the implementation. Similarly, although the various data in the system 100 is described and illustrated as being stored in distinct and separate databases, in alternate embodiments, the different types of data may be stored together. For example, in some embodiments, the itinerary database 142, inventory database 144, and accounts database 146 may be combined together into one database that stores the itinerary information 152, inventory offerings 154 and the account information 156. In such embodiment, the image database 140 storing images 150 that are associated with traveller types 158 may be provided as a separate database that can be populated with additional categorized images from third-party image suppliers, for example. As will be understood by a person skilled in the art, various types of database technologies (e.g., MySQL, Oracle™, or IBM DB2™) may be used to provide the database(s) described herein.

### Searching for and Providing Travel Itineraries

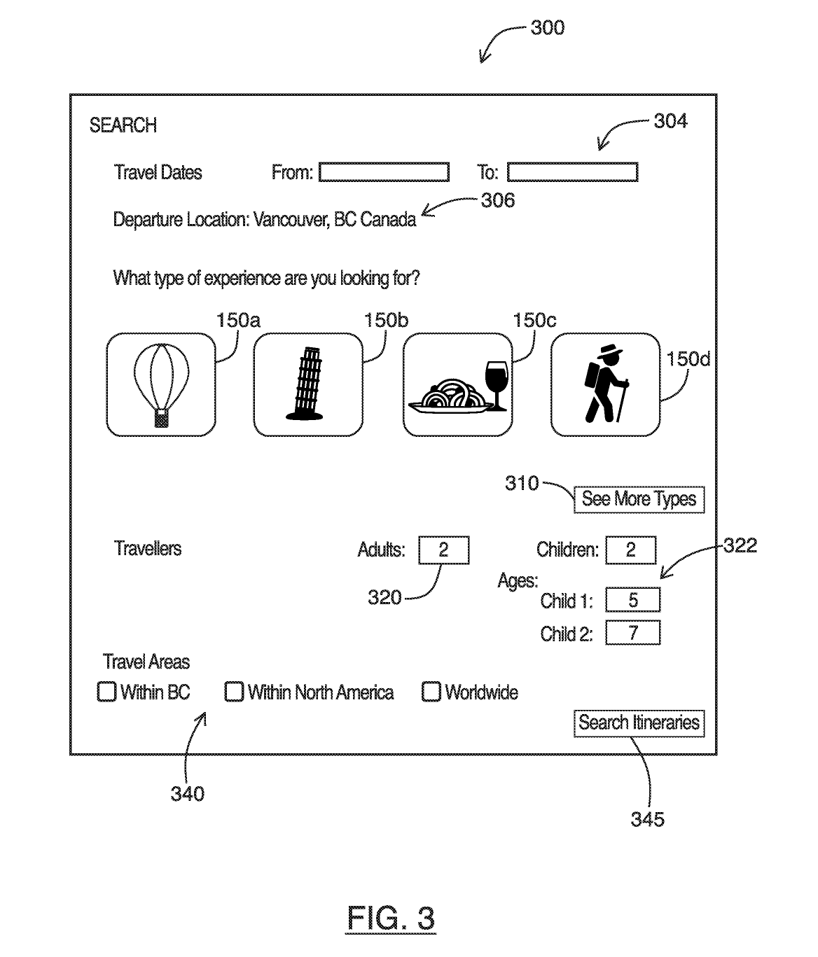

Referring to FIG. 2, shown there generally as 200 is a flow chart diagram illustrating steps for providing a travel itinerary, in accordance with an embodiment of the present disclosure. In some embodiments, the various steps described below may be performed by a processor provided in the travel server 106, executing the search and booking module 120 discussed above with respect to FIG. 1. In discussing the method illustrated in FIG. 2 below, reference will simultaneously be made to the components shown in FIG. 1, as well as the example user interfaces of FIGS. 3-5.

At step 205, the travel server 106 may provide one or more databases storing traveller types 158, travel itineraries 152 associated with traveller types 158, and images 150 associated traveller types 158. As noted, although the system 100 in FIG. 1 is illustrated with separate databases 140, 142, 148 storing these various data, in some embodiments, the data may be stored together. As illustrated in FIG. 1, the travel itineraries 152 stored in itinerary database 142 may be associated with one or more traveller types 158. Likewise, the images 150 stored in image database 140 may also be associated with one or more traveller types 158. Such associations may be performed, for example, via a foreign key to a table storing the traveller types 158, if all the data discussed herein is stored as tables within a single database.

At step 210, the travel server 106 may identify a plurality of images stored in the database. For example, this step may involve the search and booking module 120 shown in FIG. 1 querying the image database 140 for images 150. The query may be for a random group of available images 150. Additionally or alternatively, the query may be for images that are known to be associated with the most common traveller types 158. In various embodiments, the query can be configured so that each of the identified images 150 corresponds to a different traveller type 158. Once identified, the images 150 may be provided to a travel device 102 for display to a potential traveller.

Referring simultaneously FIG. 3, shown there generally as 300 is an example user interface for potential travellers to search for travel itineraries, in accordance with an embodiment of the present disclosure. For example, the user interface 300 may be shown in a web browser application or a dedicated application (or “app”) on the travel device 102. As illustrated, the user interface 300 may have user interface controls for receiving information about the trip that a potential traveller is searching for. For example, such user interface controls may be for the input of travel dates 304, a departure location 306, and information about the travellers such as the number of adults 320, and the number and ages of children on the trip 322. The user interface 300 may also have controls for receiving input about desired travel areas 340. As illustrated, the user interface 300 may also provide a number of selectable images 150a, 150b, 150c, 150d, that are each associated with different traveller types 158.

Referring back to FIG. 2, at step 215, the travel server 106 receives input selecting an image 150 of the subset of images 150 stored in the image database 140. Referring again to FIG. 3, the user interface 300 may highlight one of the displayed images 150a, 150b, 150c, 150d upon its selection. As will be understood, the input may be received via a mouse click finger press, or other human interface interaction with a customized user interface control that allows selection of images 150. Once all the various information for the trip has been entered via the various user interface controls, the user may select to search the available itineraries by activing the search button 345.

At step 220, the travel server 106 may determine the at least one traveller type associated with the selected image. Referring again to FIG. 1, this step may involve the search and booking module 120 looking up the selected image 150 in the image database 140 using, for example, an image identifier retrieved during step 210. The identifier may then be used to query the image database 150 for the traveller type 158 associated with the selected image 150. In other embodiments, the traveller type 158 of the selected image 150 may be determined in the same query that retrieved the set of selectable images 150 from the image database 140 in step 210. In such case, step 220 may not require a separate query to the image database 140 and may instead use the traveller type 158 information retrieved with the set of selectable images 150 in step 210.

At step 225, the travel server 106 may identify a subset of the plurality of travel itineraries that are associated with the determined at least one traveller type of the selected image 150. For example, referring again to FIG. 1, this step may involve the search and booking module 120 querying the itinerary database 142 to identify itineraries 152 that have been associated with the traveller type(s) 158 of the selected image 150.

At step 230, the travel server 106 may provide the subset of the plurality of travel itineraries identified in step 225, in response to the received input selecting the one image of the subset of images in step 215. This step may involve the travel server 106 returning the travel itineraries 152 that matched the traveller type(s) 158 of the selected image 150 to the travel device 102. The travel device 102 may then display these results to a potential traveller and allow for their view and selection of same. As will be understood, in various embodiments, the entire set of located itineraries need not be transmitted to travel device 102, and instead, individual results may be transmitted to the travel device as requested.

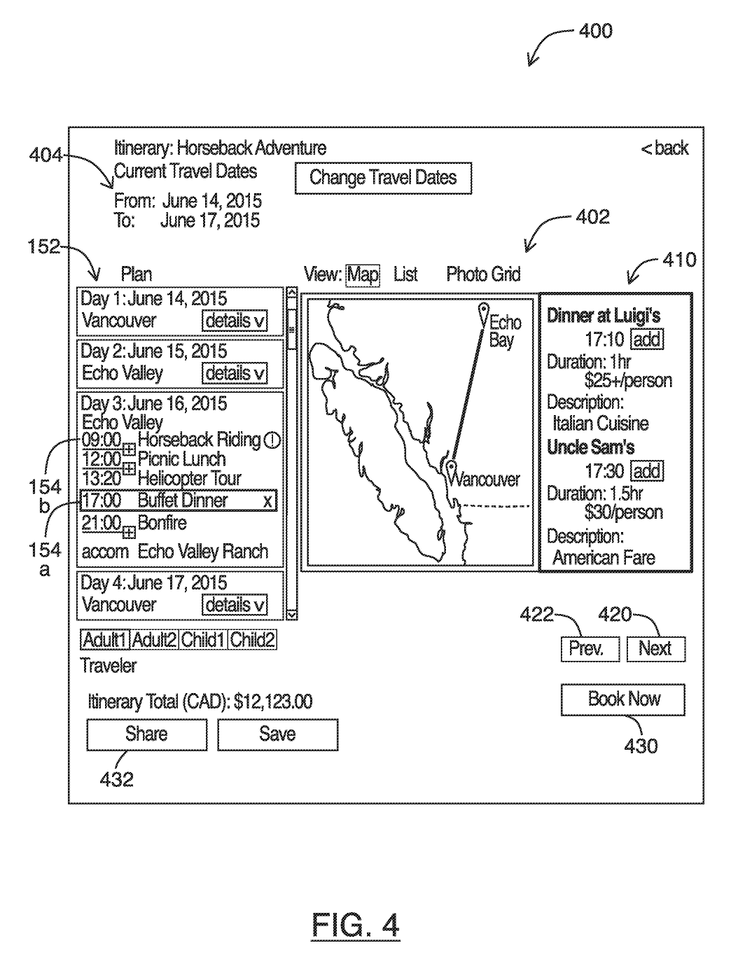

Referring to FIG. 4, shown there generally as 400 is an example user interface for displaying details of a travel itinerary, in accordance with an embodiment of the present disclosure. In various embodiments, the user interface of FIG. 4 may be shown at a travel device 102 upon selection of one of the itineraries provided in step 230 of FIG. 2. As illustrated, the user interface 400 may contain a map 402 showing locations included in the itinerary or information about travel dates 404 for the itinerary 152. The user interface 400 may also provide details of a schedule for selected itinerary 152 that may include various inventory offerings 154. For example, the illustrated itinerary 152 is a four-day trip to ‘Vancouver’ and ‘Echo Valley’ locations for the dates of ‘Jun. 14-17, 2015’. The user interface 400 is illustrated showing the details of the third day of the trip, and example inventory offerings 154 (e.g., ‘Buffet Dinner’ 154a and ‘Horseback Riding’ 154b) for the day shown. The user interface 400 may also contain a user interface control 410 to allow the user to see details of a selected inventory offering 154. For example, for the highlighted inventory offering ‘Buffet Dinner’ 154a, there may be a user interface control 410 that presents alternate inventory offerings (e.g., ‘Dinner at Luigi's’) that may be swapped for the selected inventory offering 154a.

The user interface 400 may also include user interface controls (e.g., buttons for ‘Next’ 420 and ‘Previous’ 422) for scrolling through the list of identified itineraries 152 returned at step 230 of FIG. 2. Moreover, the user interface 400 may include user interface controls for booking the itinerary (e.g., ‘Book Now’ 430) and sharing the itinerary with other potential travellers (e.g., ‘Share’ 432).

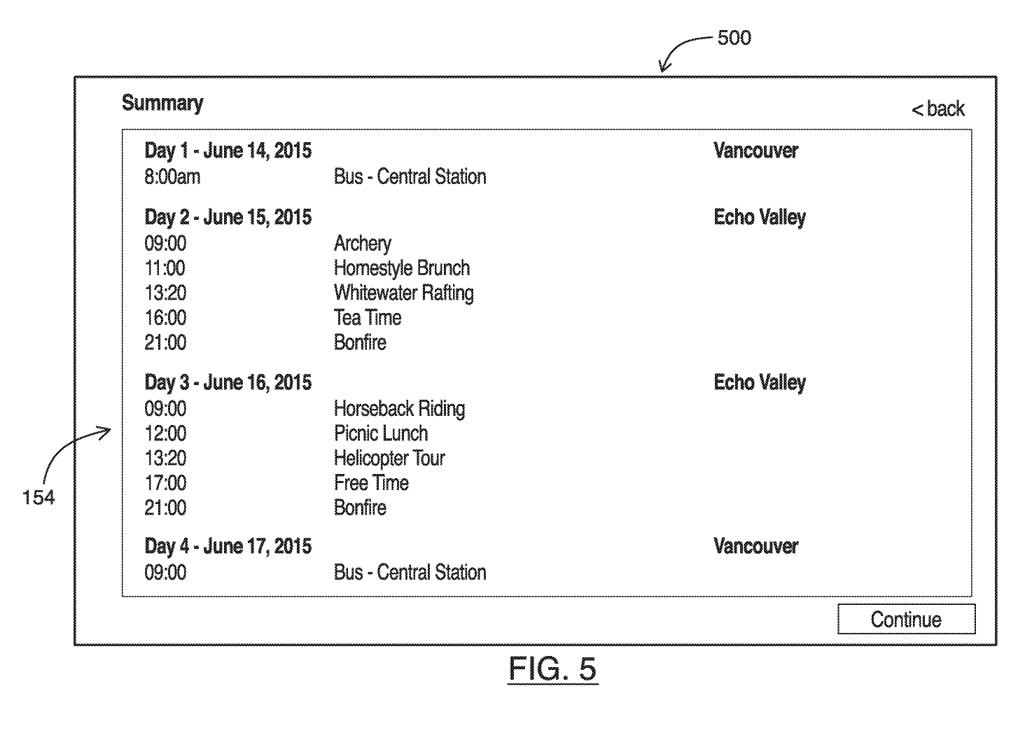

Referring simultaneously to FIG. 5, shown there generally as 500 is an example user interface of a summary view of a travel itinerary, in accordance with an embodiment of the present disclosure. In various embodiments, the search and booking module 120 may present a summary view of a given itinerary 152 when, for example, a potential traveller had selected to proceed with booking the itinerary shown in the user interface of FIG. 4 by selecting the ‘Book Now’ button 430. In such embodiments, the travel server 106 may be configured to display the summary view of the itinerary 152 prior to requesting traveller information and/or payment information from the potential traveller to complete the booking. As illustrated in FIG. 5, in some embodiments, the various inventory offerings 154 that make up the itinerary 152 are show in a list format.

### Modifying a Shared Itinerary

Referring to FIG. 6, shown there generally as 600 is a flow chart diagram illustrating steps for manipulating a travel itinerary, in accordance with an embodiment of the present disclosure. In some embodiments, the various steps described below may be performed by a processor in the travel server 106, executing the search and booking module 120 (as shown in FIG. 1). In discussing the method illustrated in FIG. 2 below, reference will simultaneously be made to the components shown in FIG. 1, as well as the example user interfaces in FIGS. 4, and 7-8.

At step 605, the travel server 106 may receive input, from a first traveller device, selecting an itinerary, the itinerary having a plurality of inventory offerings that are each associated with a geographical location (which may be a location near an address, a location near a known tourist destination, a location near specific roads, and/or the like). For example, this step may be performed when a potential traveller is reviewing details of an itinerary returned from the method of FIG. 2. For example, referring again to FIG. 4, once the potential traveller has reviewed the details of a selected itinerary, they may activate the ‘Share’ button 432 to share the itinerary with another traveller (e.g., a friend or family member) with which they would like to travel.

At step 610, in response to the received input selecting the itinerary, the travel server 106 may provide an itinerary identifier for identifying the selected itinerary, wherein the itinerary identifier is transmittable to a second traveller device. Referring simultaneously again to FIGS. 1 and 4, upon a potential traveller selecting the ‘Share’ button 432 in the user interface of FIG. 4, the potential traveller may be presented with options to enter user identification information of the second potential traveller that they would like to share the itinerary with. This may involve the first potential traveller entering contact information of the second potential traveller (e.g., an email address, phone number, social medial handle and/or user name, or a combination of any of the foregoing). The search and booking module 120 of the travel server 106 may then construct a message using the contact information for sending by the first potential traveller to the second potential traveller. The constructed message may contain: an itinerary identifier for the itinerary that is being shared, and links to access the travel server 106 for viewing and/or modifying the shared itinerary 152. The itinerary identifier may be stored in the itinerary database 142 of the travel server 106. In some embodiment, the constructed message may include an update (e.g., a ‘status update’) entered on the first potential traveller's social media account that is accessible by only the second potential traveller. In some embodiments, the update is accessible by other potential travellers.

At step 615, the itinerary identifier may be transmitted to the second traveller device. This may be performed when the first potential traveller using the first traveller device 102 confirms that the message constructed by travel server 106 is to be transmitted to the second traveller device 102′. As will be understood, the transmission may in some embodiments be performed by the travel server 106 itself (e.g., through an email originating directly from the travel server 106). Additionally or alternatively, the transmission may be performed using other communication channels (e.g., email, direct messages via social networks, direct posting on the second potential traveller's social network account, or a combination of any of the foregoing) available on the traveller device 102 of the first potential traveller. As used herein, “social network” or “social media” means Internet based social networks, such as Facebook™, Twitter™, Instagram™, Wechat™, Google Plus™, and the like.

At step 620, the travel server 106 may receive input, from the second traveller device 102′, including the itinerary identifier for the selected itinerary 152 and a request to modify an inventory offering of the selected itinerary 152. The input may have been a result of the second potential traveller accessing the links for viewing and modifying the shared itinerary 152 included in the message transmitted by the first potential traveller. The inclusion of the itinerary identifier in the input received by the travel server 106 allows the travel server 106 to locate the stored itinerary 152 in the itinerary database 142 that was viewed by the first potential traveller, so as to present the same information to the second potential traveller.

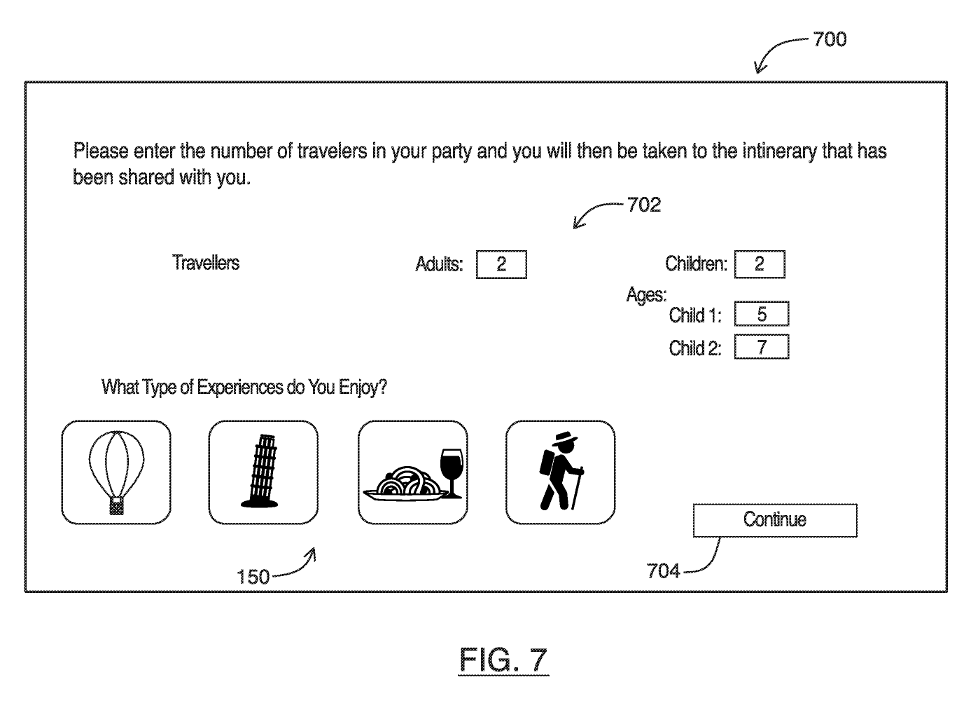

Referring to FIG. 7, shown there generally as 700 is an example user interface presented to a potential traveller for verifying their ability to modify an itinerary that has been shared with them, in accordance with an embodiment of the present disclosure. In some embodiments, prior to allowing the second traveller device 102′ access to modify the itinerary that has been shared, the second traveller device 102′ may display a user interface that verifies the identity of the second potential traveller and their ability to modify the shared itinerary. For example, the user interface 700 may request information that would be specific to the trip that is being booked. As the first potential traveller would likely have shared information about the trip to the second potential traveller via other means (e.g., orally or other messaging means apart from the particular message that shared the itinerary with the second traveller), the second potential traveller would likely be in possession of this information so as to allow them to pass the verification. As illustrated, the user interface 700 in FIG. 7 contains a number of user interface controls 702 that request information related to the members of the party for which the itinerary 152 has been shared. For example, this information includes the number of adults and children, as well as the age of the children. Referring briefly back to FIG. 3, this information would have been entered using user interface controls 320 and 322 in the user interface 300 when the first potential traveller entered search criteria for searching itineraries. In some embodiments, verification of the identity of the second potential traveller includes a code generated by travel server 106 and sent to second potential traveller in a separate message (e.g., by email or direct message on social network accounts). In some embodiments, verification of the identity of the second potential traveller includes answering a question provided by the first potential traveller.

It will be understood that although the user interface in FIG. 7 is shown as requesting information related to the members of the party for which the itinerary 152 has been shared, other information about the trip may be used. For example, such information may include the dates of the trip or the travel areas for the trip that the first potential traveller had narrowed the search for itineraries down to (e.g., as may have been entered into the user interface controls 304 and 340 respectively of FIG. 3).

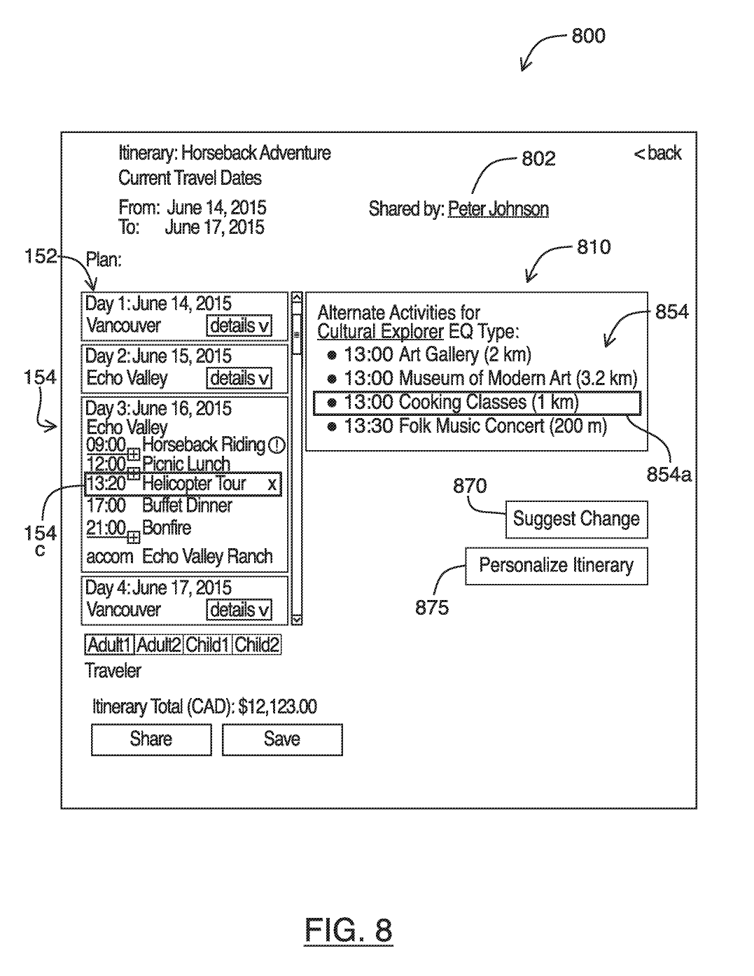

Referring still to FIG. 7, the user interface 700 presented at the second traveller device 102′ may also contain a set of images 150 selected from the image database 140 that are associated with traveller types 158. As described above with respect to the user interface 300 shown in FIG. 3, the selection of one of the images 150 at the second traveller device 102′ may provide an indication of the traveller type 158 of the second potential traveller. As discussed below with respect to FIG. 8, the traveller type 158 of the second potential traveller may be used to identify alternate inventory offerings 154 that are suitable for the second potential traveller. Once the second potential traveller has entered the verification information, the second potential traveller may proceed with viewing and editing the shared itinerary by activating the ‘Continue’ button 704.

Referring back to FIG. 6, at step 625, the travel server 106 may provide an alternate inventory offering for the inventory offering requested to be modified, the alternate inventory offering being associated with the geographical location of the inventory offering requested to be modified. Once the second potential traveller has passed the verification mechanism of FIG. 7, they may be presented with a user interface that shows them details of the shared itinerary 152.

Referring to FIG. 8, shown there generally as 800 is an example user interface for modifying an inventory offering of a shared itinerary 152, in accordance with an embodiment of the present disclosure. The user interface 800 may allow the second potential traveller to review the itinerary 152 that has been shared with them. In this manner, the itinerary information and how it is presented may be similar to the way the itinerary information was shown in the user interface 400 of FIG. 4 that originally provided such information at the first traveller device 102. For example, the left hand side of the user interface 800 may provide an overview of the itinerary 152 containing various inventory offerings 154 (e.g., the example itinerary shown in FIG. 8 is the same 4-day trip to ‘Vancouver’ and ‘Echo Valley’ for the dates of ‘Jun. 14-17, 2015’).

However, the user interface 800 may provide additional elements to indicate that it is being shown at a second traveller device 102′ to a second potential traveller. For example, the user interface 800 may contain a notice 802 to indicate the name of the first potential traveller that shared the itinerary with them (e.g., ‘Shared by: Peter Johnson’). Also, upon selection of a given inventory offering 154 (e.g., the ‘Helicopter Tour’ 154c) in the shared itinerary 152, the user interface 800 may provide user interface controls 810 that present alternate inventory offerings 854 that may be swapped in place of the selected inventory offering 154c in the itinerary 152.

In generating the list of alternate inventory offerings 854 that may be suitable for the second potential traveller, the search and booking module 120 may query the inventory database 144 (as shown in FIG. 1) to locate inventory offerings 154 that are associated with the traveller type 158 of the second potential traveller (e.g., as was determined via the selected image 150 in the user interface 700 of FIG. 7). As illustrated in the example user interface of FIG. 8, the determined traveller type 158 of the second potential traveller was a ‘Cultural Explorer’ traveller type 158. As a result, the alternate inventory offerings 854 that are located and displayed are for cultural activities (e.g., ‘Art Gallery’, ‘Museum of Modern Art’, ‘Cooking Classes’, and ‘Folk Music Concert’) that are suitable for a person of such a traveller type 158.

Also, in identifying the alternate inventory offerings 854, the search and booking module 120 (as shown in FIG. 1) may limit the search to inventory offerings 154 in the inventory database 144 that are within the geographical location of the inventory offering 154c that is being requested to be modified. For example, this may be implemented by configuring the query to locate alternate inventory offerings 854 to be a preset distance away from the location of the inventory offering 154c selected to be modified. In various embodiments, this preset distance may be modifiable by an administrator of the travel server 106. Additionally or alternatively, the preset distance may be configured by the second potential traveller (e.g., by providing a user interface control (not shown) that the second potential traveller may enter the distance for). In a further embodiment, the preset distance may be determined by the travel server 106 based on user-selectable options that approximate the distance desired by the second potential traveller. For example, these user-selectable options may include: ‘within walking distance’, ‘within a short bus ride’, or ‘within a 5 minute drive’ which may be approximated ‘500 m’, ‘3 km’ and ‘5 km’ respectively (with such approximate distances being configurable by an administrator of the travel server 106).

In various embodiments, a similar type of narrowing search may be performed with respect to the time of the inventory offering 154c selected to be modified. For example, the alternate inventory offerings 854c may have a start time that is within a preset amount of time before and/or after the start time of the inventory offering 154c to be modified.

By limiting the searches for alternate inventory offerings 854 with these geographical and temporal restrictions, the alternate inventory offerings 854 can be selected by the second potential traveller without modifying the overall structure of the shared itinerary 152. That is, a global change to the shared itinerary is not required and the second potential traveller may potentially partake in the available alternate inventory offerings 854 while the first potential traveller partakes in the original inventory offering 154 that was desired to be modified. For example, in the illustrated scenario of FIG. 8 where the inventory offerings 154 are activities, the second potential traveller may select to partake in the ‘Cooking Class’ inventory offering 854a while the first potential traveller partakes in the ‘Helicopter Tour’ inventory offering 154c.

In various embodiments, the user interface controls 810 displaying the alternate inventory offerings 854 may also be configured to display the proximate distances to the inventory offering 154c selected to be modified. For example, in the example user interface of FIG. 8, it is shown that the ‘Cooking Classes’ 854a is ‘1 km’ away from ‘Helicopter Tour’ activity 154c requested to be modified. Similarly, the user interface controls 810 may display the start times for the alternate inventory offerings 854. Providing such distance and start time information may assist the second potential traveller in determining the ease with which they can partake in the alternate inventory offerings 854.

In various embodiments, additional user-configurable options may be presented to refine the alternate inventory offerings 854 viewable in the user interface 800 of FIG. 8. For example, if the itinerary 152 includes a number of inventory offerings 154 that are all supplied by the same supplier, then a user interface control may be provided to search only for alternate inventory offerings 854 provided by the same supplier, so that the travel server 106 may introduce this additional limitation into the search query and the alternate inventory offerings 854 that are displayed are more targeted. Additionally or alternatively, the inventory offerings 154 of the itinerary 152 may generally be provided at a particular venue (e.g., a resort), and it may be possible to refine the search for alternate inventory offerings 854 to search for alternate inventory offerings 854 which are available from the same venue.

Referring again to FIG. 8, once the second potential traveller has selected an alternate inventory offering 854a that they would like to modify the shared itinerary 152 with, multiple options may be presented for selection. As illustrated, there is an option to suggest the change to the shared itinerary (e.g., button 870), which may allow the second potential traveller to suggest a global change to the shared itinerary such that the alternate inventory offering 854a selected by the second potential traveller would replace the original inventory offering 154c in the itinerary. If this option is selected, the travel server 106 may send a message to the first potential traveller so that he or she is notified of the change that the second traveller desires. As will be understood, this message may be communicated to the first potential traveller in various ways. For example, this message may be provided via an internal message posted to the account information 156 stored in the account database 146 (as shown in FIG. 1) of the first potential traveller, or via an external communication method such as e-mail. When the message is accessed, the first potential traveller may be presented with options to approve, reject, or suggest further alternate inventory offerings 854 to modify the shared itinerary 152 with.

In addition to suggesting a change to the shared itinerary (button 870), the user interface 800 of FIG. 8 may also contain an option 875 to create a personalized itinerary based off of the shared itinerary 152. Selecting such an option would result in the creation of an additional itinerary that shares common inventory offerings 154 with the shared itinerary 152, except that the inventory offering 154c selected to be modified will be replaced with the alternate inventory offering 854c. The personalized itinerary may then be stored in itinerary database 142 (as shown in FIG. 1).

In some embodiments, the personalized itinerary may be stored as a complete itinerary 152 which duplicates data relating to the inventory offerings 154 that are common with the shared itinerary 152.

Alternatively, the personalized itinerary may be stored as: only information for the parts of the itinerary that have been modified by the second potential traveller (e.g., a delta), and a reference or link to the shared itinerary. In this manner, the itinerary information that is common with the shared itinerary need not be duplicated and storage space can be saved. Moreover, providing a link in the personalized itinerary to the shared itinerary may create an association between the two itineraries. This may allow the two itineraries to be located together during a search. For example, the shared itinerary may be designated a ‘head’ itinerary and the personalized itinerary may be designated as a ‘subsidiary’ itinerary that are related, so that if subsequent changes are made to the ‘head’ itinerary, such changes are also reflected in the ‘subsidiary’ itinerary.

### Itinerary Creation by a Curator

As noted above with respect to FIG. 1, the travel server 106 may execute an itinerary creation module 122 that is accessible by a curator using a curator device 108. FIGS. 9-11 show several example user interfaces that may be generated by the itinerary creation module 122 for display at the curator device 108.

Referring to FIG. 9, shown there generally as 900 is an example user interface for creation of an itinerary, in accordance with an embodiment of the present disclosure. The user interface 900 may contain various user interface controls that allow a curator to enter information about an itinerary, such as an itinerary name, the total days of the itinerary, the dates of availability for the itinerary, whether an itinerary is active and available to be searched for, short/long descriptions for the itinerary, and/or the selection of an image for representing the itinerary. Particularly, the user interface 900 may also have controls 902 (shown in this embodiment as selectable checkboxes for different EQ Types) that allow the curator to select the traveller types 158 to be associated with the itinerary being created.

Additionally, the user interface 900 may include controls 930 to search for available inventory offerings 154 that can be added to the itinerary 152 being created. The inventory offerings 154 that populate the user interface control 930 may be narrowed by filtering the contents of the inventory database 144 according to various factors. For example, as illustrated in FIG. 9, there are additional controls for filtering the inventory offerings 154 according to traveler type 910 (shown as selectable checkboxes for different EQ Types), inventory type 915 (shown as checkboxes besides different categories of inventory offerings 154 such as ‘accommodation’, ‘travel’ or ‘activity’), and locations. As will be understood, other filters for refining the inventory offerings 154 viewed in the user interface control 930 may also be possible.

Similar to the user interfaces discussed above with respect to FIGS. 4 and 8, the left-hand pane of user interface 900 may show the inventory offerings 154 that have been added to the itinerary 152. The pane may have controls that allow the insertion 925 (shown as a ‘+’) or deletion 935 (shown as an ‘x’) of inventory offerings 154 into/from itinerary 152. As illustrated, an inventory offering 154 shown in the inventory offering control 930 may also be added using the inventory offering control 930 using an ‘add’ button 965. Once the curator is satisfied with the created itinerary 152, a ‘save’ button 970 is available which, when activated, may cause the data related to the itinerary 152 to be saved into the itinerary database 142.

Referring still to FIG. 9, as illustrated, the user interface 900 contains controls 902 for associating a created itinerary 152 with traveller types 158, and separately, controls 910 for filtering the inventory offerings 154 that are viewable in the inventory offerings user interface control 930 based on traveller types 158. However, in some embodiments, the two separate user interface controls may be configured to operate in conjunction with each other.

For example, in one embodiment, the controls 902 used for associating the traveller types 158 with the itinerary 152 may be used also to filter the inventory offerings 154 that are viewable in the inventory offerings user interface control 930 (such that the traveller type filter control 910 may be omitted). In such embodiment, the traveller type 158 that is selected to be associated with the travel itinerary 152 may be considered to be pre-determined, such that only inventory offerings 154 that are associated with the pre-determined traveller type 158 selected in user interface control 902 are available to be selected for association with the travel itinerary 152.

In an alternative embodiment, the traveller type(s) 158 that are to be associated with the itinerary 152 may be determined from the traveller types 158 with which the curator uses to populate the itinerary 152. For example, in such embodiment, the user interface control 902 may be omitted, and the traveller types 158 associated with the itinerary 152 may be assigned based on the traveller type(s) 158 selected in the user interface control 910 used to filter the viewable inventory offerings 154 shown in user control 930.

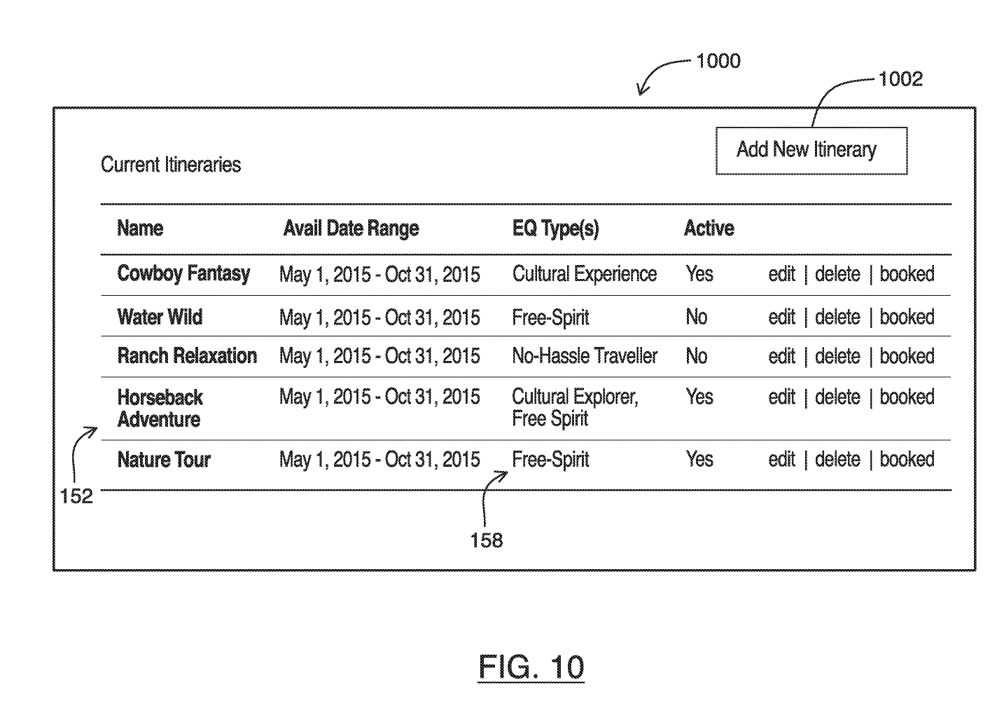

Referring to FIG. 10, shown there generally as 1000 is an example user interface for organizing created travel itineraries, in accordance with an embodiment of the present disclosure. As illustrated, a list of created itineraries 152 may provide information about multiple itineraries at the same time, such information including the name of the itinerary, available date ranges, traveller types 158 (shown as ‘EQ Types’) associated with the itineraries 152, whether the itineraries 152 are active, user interface options that allow their editing/deleting, and an indication of whether the itineraries 152 has been booked. The user interface 1000 may also include a button 1002 for adding new itineraries, which upon activation, may result in the presentation of the user interface 900 of FIG. 9.

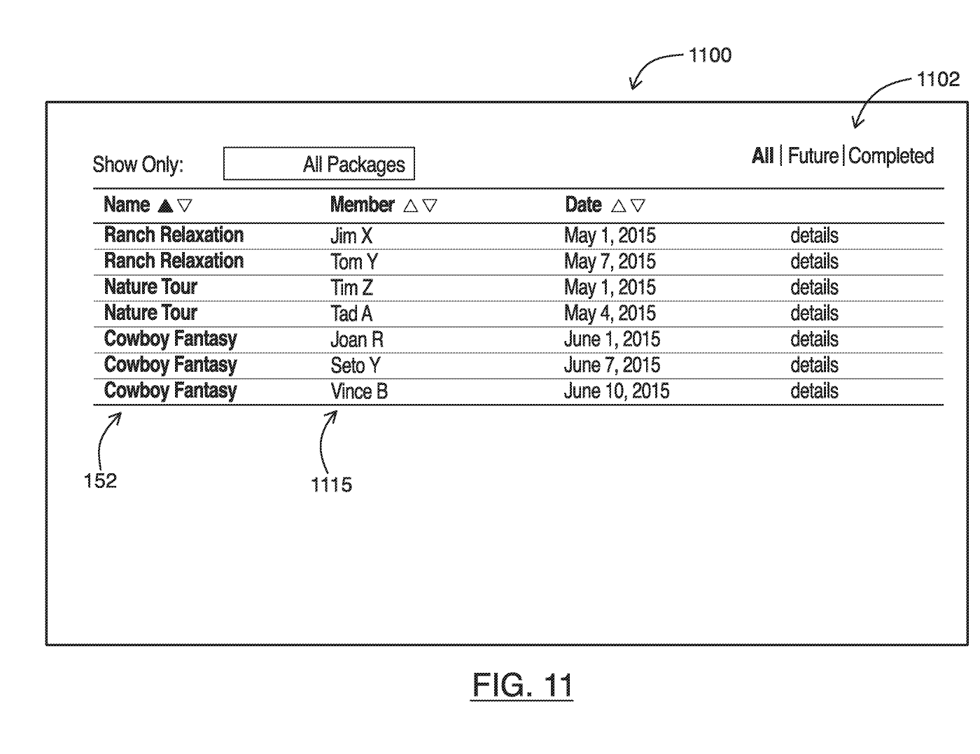

Referring to FIG. 11, shown there generally as 1100 is an example user interface for viewing booked travel itineraries, in accordance with an embodiment of the present disclosure. As illustrated, a list of booked itineraries 152 and their respective booking parties 1115, booked dates and links for accessing the details of the bookings are shown. The user interface 1100 may also include a user interface control 1102 for selecting to view all, future, or completed bookings.

### Supplier Entry of Inventory Offerings

As noted above with respect to FIG. 1, the travel server 106 may execute a supplier module 124 that is accessible by a supplier using a supplier device 110 for entering information about inventory offerings 154 into the inventory database 144. FIGS. 12-17 show several example user interfaces that may be generated by the itinerary supplier module 124 for display at the supplier device 110.

Referring to FIG. 12, shown there generally as 1200 is an example user interface for inserting information about inventory offerings that may be associated with a travel itinerary, in accordance with an embodiment of the present disclosure. The user interface 1200 may have a variety of different user interface controls for entering information related to an inventory offering 154, such as the name of the offering, categories and subcategories associated with the inventory offering 154, location, date availability, description, price, images, age restrictions, and additional features. The user interface 1200 of FIG. 12 may also contain a user interface control 1202 (shown as user-selectable check boxes beside various ‘EQ Types’) for selecting traveller type(s) 158 that are to be associated with the particular inventory offering 154 being created. Once created (e.g., via activation of the ‘Save’ button 1210), the inventory offering 154 may be saved into the inventory database 144 (as shown in FIG. 1), so that the inventory offering 154 may be searchable in the processes described above and added to itineraries 152.

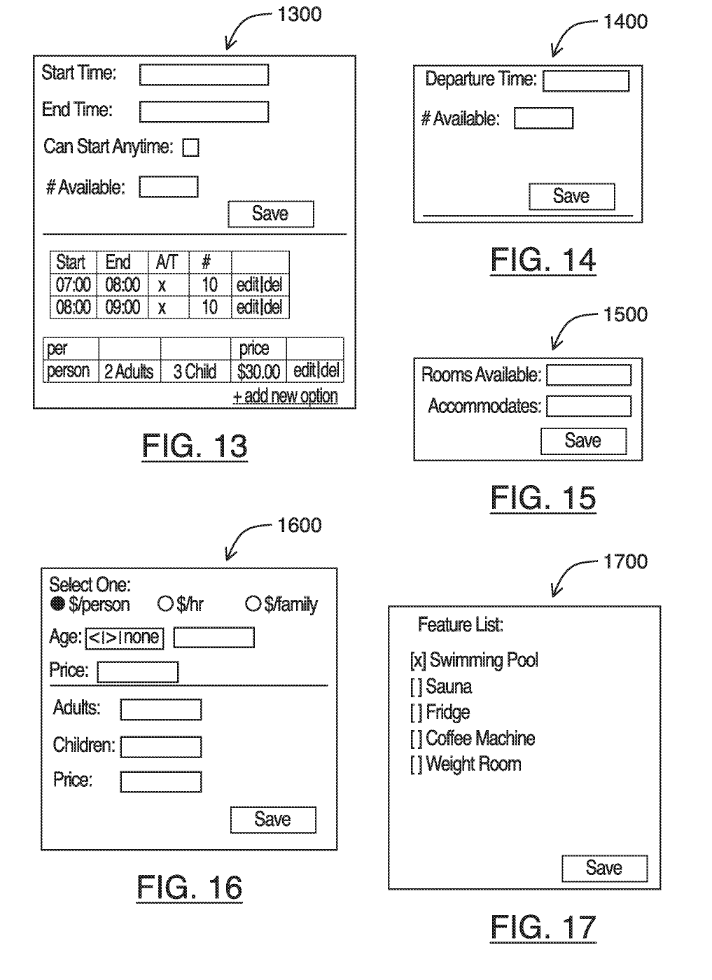

FIGS. 13-17 show various example user interfaces that may be displayed to receive information related to inventory offerings 154 of particular types. For example, referring to FIG. 13, shown there generally as 1300 is an example user interface for entering additional information for an inventory offering 154 that is an activity with start and end times, and has a number of spaces available. Referring to FIG. 14, shown there generally as 1400 is an example user interface where the activity has only a departure time and a number of spaces available. Referring to FIG. 15, shown there generally as 1500 is an example user interface for an ‘accommodation’ type inventory offering (e.g., a cabin), which allows input of information related to number of rooms available, and the number of people that the venue can accommodate. Referring to FIG. 16, shown there generally as 1600 is a user interface that may be presented to allow entering of pricing information for a given inventory offering 154. Referring to FIG. 17, shown there generally as 1700 is a user interface in which a supplier may select to indicate whether their particular inventory offering 154 has certain features that may be made available for a given type of inventory offering 154. For example, as illustrated, the user interface 1700 is for an ‘accommodation’ type inventory offering, and the user interface 1700 allows the supplier the option to select whether their particular inventory offering 154 comes with features such as a ‘swimming pool’, ‘sauna’, or ‘weight room’.

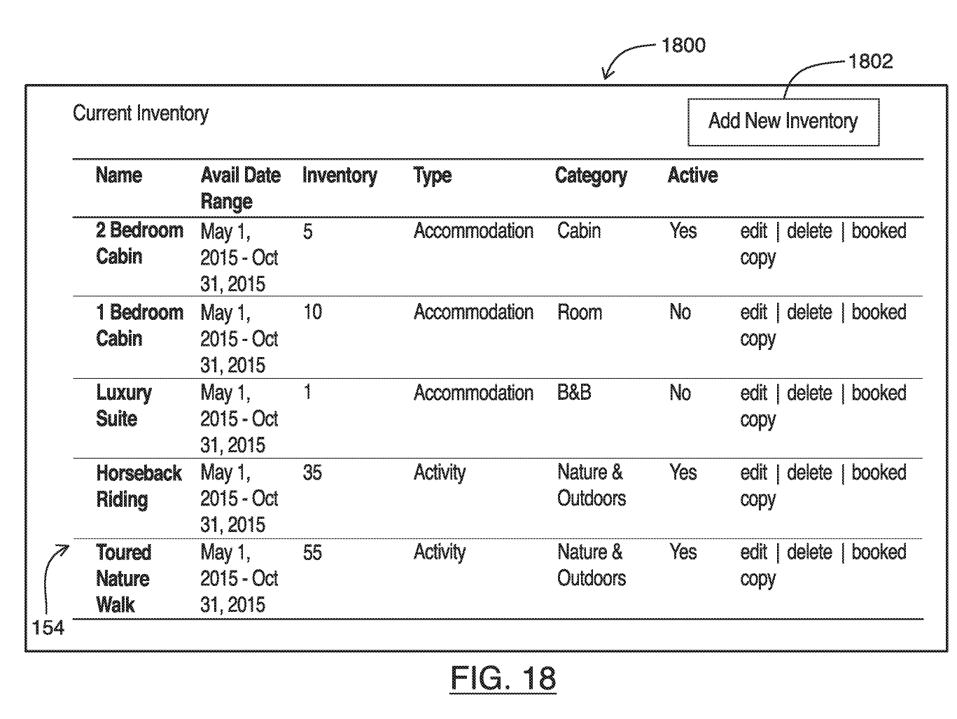

Referring to FIG. 18, shown there generally as 1800 is an example user interface for organizing created inventory offerings 154, in accordance with an embodiment of the present disclosure. As illustrated, a list of created inventory offerings 154 may provide information about multiple inventory offerings 154 at the same time, such information including the name of the inventory offerings 154, available date ranges, the number of inventory available, the type of inventory offerings 154, the category of inventory offerings 154, whether the inventory offerings 154 are active, options that allow the editing/deleting/copying of the inventory offerings 154, and an indication of whether the inventory offerings 154 have been booked. The user interface 1800 may also include a button 1802 for adding new itineraries, which upon activation, may result in the presentation of the user interface of FIG. 12.

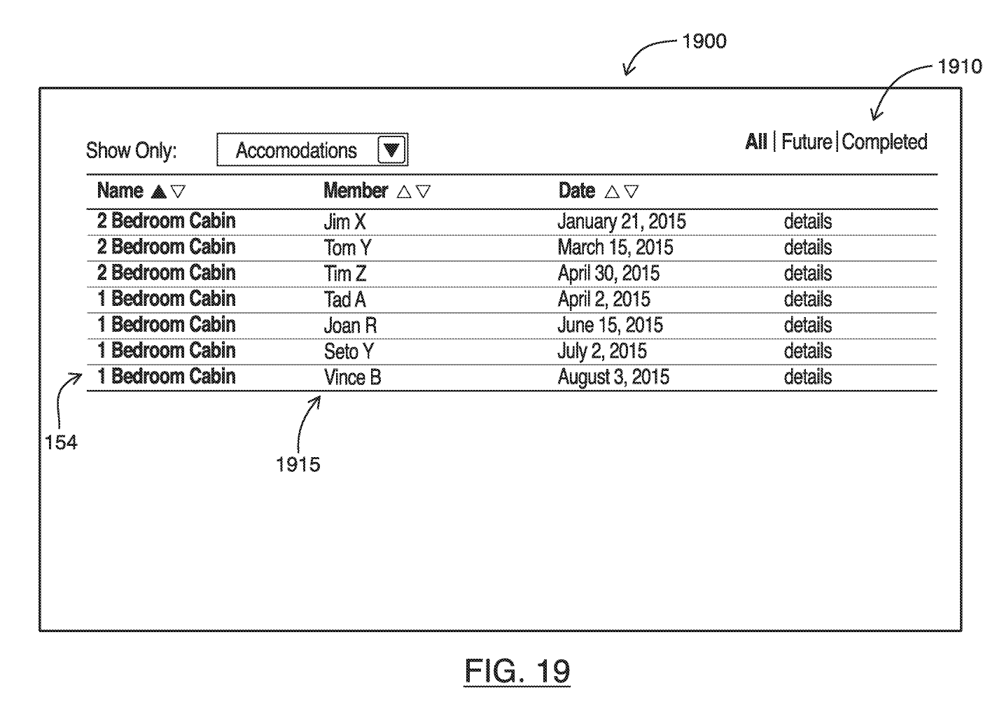

Referring to FIG. 19, shown there generally as 1900 is an example user interface for viewing booked inventory offerings, in accordance with an embodiment of the present disclosure. As illustrated, a list of booked inventory offerings 154 and their respective booking parties 1915, booked dates and links for accessing the details of the bookings are shown. The user interface 1900 may also include a control 1910 for selecting to view all, future, and/or completed bookings.

### Alternate User Interfaces

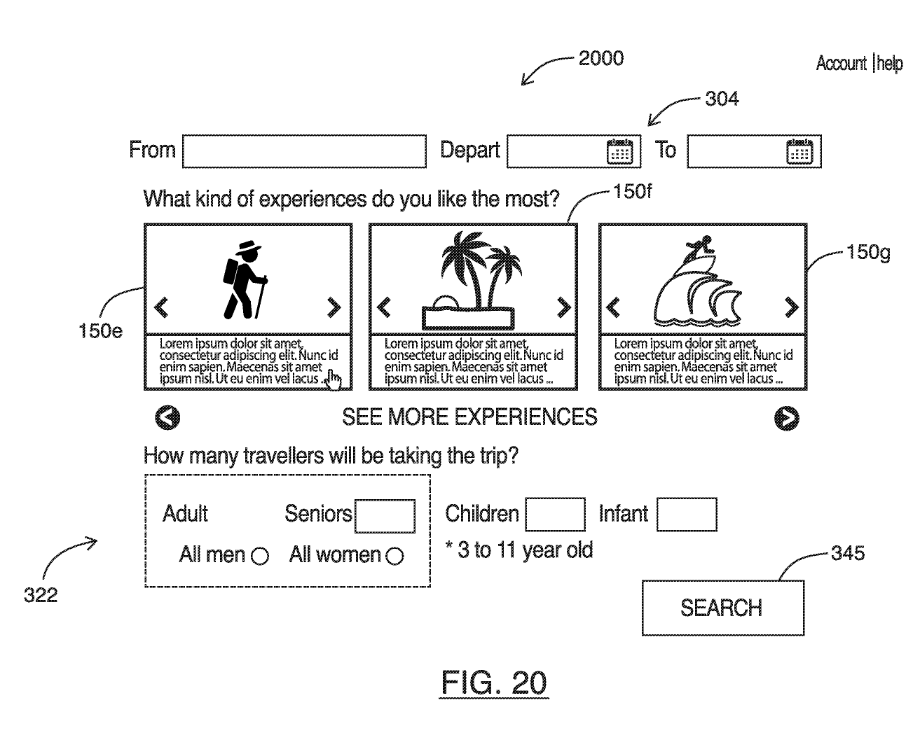

Referring to FIG. 20, shown there generally as 2000 is another example user interface for potential travellers to search for travel itineraries, in accordance with another embodiment of the present disclosure. The user interface 2000 of FIG. 20 is similar to the user interface 300 of FIG. 3 in that a potential traveller is presented with options 304 for inputting details about the trip they desire to take. The user interface 2000 includes controls 322 for the entering information about the parties going on the trip, and a ‘search’ button 345 that can be activated once details about the desired trip is entered. The user interface 2000 may also include a number of images 150e, 150f, 150g for a potential traveller to select, so as to indicate the traveller type(s) 158 of the itineraries and/or inventory offerings 154 that may be suitable for such potential traveller.

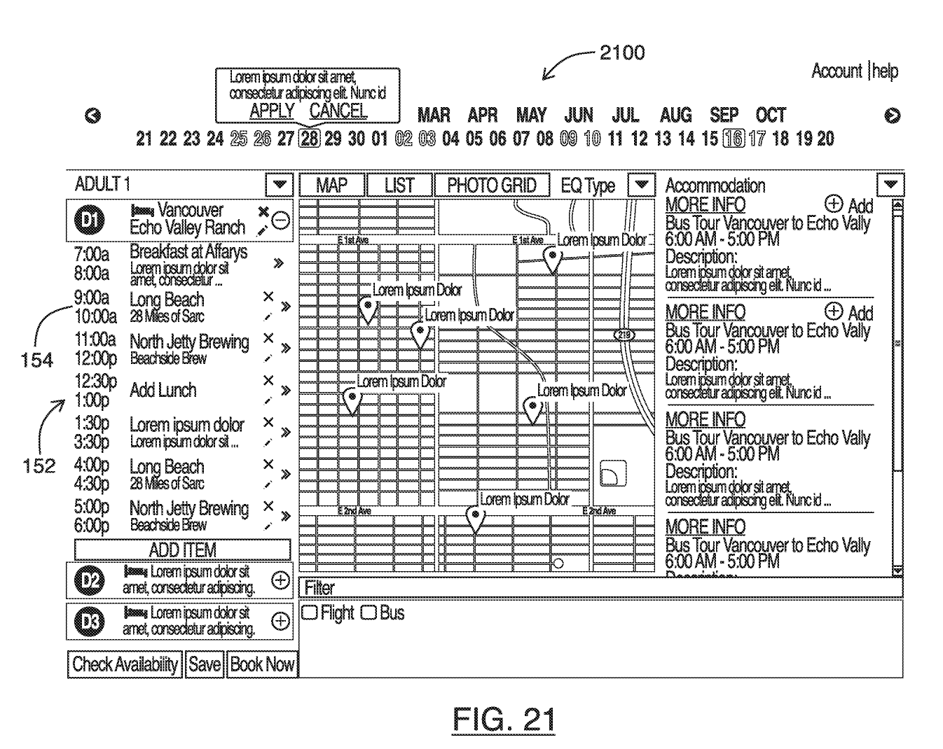

Referring to FIG. 21, shown there generally as 2100 is another example user interface showing a summary view of a travel itinerary, in accordance with another embodiment of the present disclosure. The user interface 2100 of FIG. 21 is similar to the user interface 400 of FIG. 4 in that a potential traveller is presented with a left-hand pane showing a selected itinerary 152, with its constituent inventory offerings 154. On the top pane, a calendar user interface control is shown. On the right pane, a map control and information about alternate inventory offerings 154 that may be swapped with a given inventory offering 154 in the itinerary 152 is shown.

### Seeding and Updating the Image Database

As discussed above with respect to FIG. 1, the system 100 of the present embodiments may include an image database 140 storing images 150 that are associated with traveller types 158. In various embodiments, the associations between the plurality of images 150 and their respective traveller types 158 may be pre-determined such that images 150 are loaded into the database 140 already provided with such associations.

Additionally or alternatively, the system 100 of FIG. 1 may be provided with software functionality that is configured to administer an electronic survey, in which uncategorized images are shown to users in an electronic survey, and based on the input from users, the uncategorized images may be associated with traveller types.

For example, such an electronic survey may involve: making available for display an uncategorized image that has not been associated with any traveller type 158; providing one or more of the plurality of traveller types 158 as options to be selected to be associated with the uncategorized image; receiving input selecting a traveller type 158 of the one or more of the plurality of traveller types 158 as being associated with the uncategorized image; and storing an association between the selected traveller type and the uncategorized image in the database 140. During the conducting of such an electronic survey, uncategorized images may be transmitted to a client device for display at the client device, and the input selecting the images and indicating what type of traveller type is associated with it may be received by the travel server 106 from the client device. In some embodiments, uncategorized images may be categorized for association with different traveller type 158 based on the number of positive responses from travellers that have been identified with a traveller type 158.

All publications and patent applications mentioned in this specification are herein incorporated by reference to the same extent as if each individual publication or patent application was specifically and individually incorporated by reference.

While the foregoing disclosure has been described in some detail for purposes of clarity and understanding, such disclosure is provided by way of example only. It will be appreciated by one skilled in the art, from a reading of the disclosure, that various changes in form and detail of these exemplary embodiments can be made without departing from the true scope of the disclosure, which is limited only by the appended claims. For example, it should be understood that acts and the order of the acts performed in the processing described herein may be altered, modified and/or augmented yet still achieve the desired outcome. While processes or blocks are presented in a given order, alternative examples may perform routines having steps, or employ systems having blocks, in a different order, and some processes or blocks may be deleted, moved, added, subdivided, combined, and/or modified to provide alternatives or subcombinations. Each of these processes or blocks may be implemented in a variety of different ways. Also, while processes or blocks are at times shown as being performed in series, these processes or blocks may instead be performed in parallel, or may be performed at different times.

The steps of a method in accordance with any of the embodiments described herein may be performed in any order, whether or not such steps are described in the claims, figures or otherwise in any sequential numbered or lettered manner. Also, in the various user interfaces illustrated in the figures, it will be understood that the illustrated user interface text and controls are provided as examples only and are not meant to be limiting with regards to their appearance. Other suitable ways of arranging and modifying the appearance of user interface elements may be possible.

Those skilled in the relevant art will appreciate that aspects of the system can be practised with other communications, data processing, or computer system configurations, including: Internet appliances, cloud computing, multi-processor systems, microprocessor-based or programmable devices, network Personal Computers (PCs), mini-computers, mainframe computers, and the like.

Software and other modules may be accessible via local memory, via a network, via a browser or other application in an Application Service Provider (ASP) context, or via other means suitable for the purposes described herein. Examples of the technology can also be practised in distributed computing environments where tasks or modules are performed by remote processing devices, which are linked through a communications network, such as a Local Area Network (LAN), Wide Area Network (WAN), or the Internet. In a distributed computing environment, program modules may be located in both local and remote memory storage devices. Data structures (e.g., containers) described herein may include computer files, variables, programming arrays, programming structures, or any electronic information storage schemes or methods, or any combinations thereof, suitable for the purposes described herein.

As used herein, the wording “and/or” is intended to represent an inclusive-or. That is, “X and/or Y” is intended to mean X or Y or both. Moreover, “X, Y, and/or Z” is intended to mean X or Y or Z or any combination thereof.

Where a component (e.g. a model, processor, scheduler, display, data store, software module, assembly, device, circuit, etc.) is referred to above, unless otherwise indicated, reference to that component should be interpreted as including as equivalents of that component any component which performs the function of the described component (i.e., that is functionally equivalent), including components which are not structurally equivalent to the disclosed structure which performs the function in the illustrated exemplary embodiments of the invention.

Specific examples of systems, methods and apparatus have been described herein for purposes of illustration. These are only examples. The technology provided herein can be applied to systems other than the example systems described above. Many alterations, modifications, additions, omissions, and permutations are possible within the practice of this invention. This invention includes variations on described embodiments that would be apparent to the skilled addressee, including variations obtained by: replacing features, elements and/or acts with equivalent features, elements and/or acts; mixing and matching of features, elements and/or acts from different embodiments; combining features, elements and/or acts from embodiments as described herein with features, elements and/or acts of other technology; and/or omitting combining features, elements and/or acts from described embodiments

It is therefore intended that the following appended claims and claims hereafter introduced are interpreted to include all such modifications, permutations, additions, omissions, and sub-combinations as may reasonably be inferred. The scope of the claims should not be limited by the preferred embodiments set forth in the examples, but should be given the broadest interpretation consistent with the description as a whole.

Accordingly, the scope of the invention is to be construed in accordance with the substance defined by the following claims.

What is claimed is:

1. A system for identifying travel itineraries, comprising:
one or more databases storing:
a plurality of traveller types;
a plurality of travel itineraries, wherein each of the plurality of travel itineraries is associated with at least one of the plurality of traveller types; and
a plurality of images, wherein each of the plurality of images is associated with at least one of the plurality of traveller types; and
a processor configured to:
identify a subset of the plurality of images;
receive input selecting an image of the subset of images;
determine, from the one or more databases, the at least one traveller type associated with the selected image;
identify, from the one or more databases, a subset of the plurality of travel itineraries that are associated with the determined at least one traveller type; and
provide the subset of the plurality of travel itineraries, in response to the received input selecting the one image of the subset of images.

2. The system of claim 1, wherein the plurality of traveller types correspond to psychographic classifications.

3. The system of claim 2, wherein the psychographic classifications comprise Explorer Quotient™ profile types.

4. The system of claim 1, wherein the one or more databases store information for a plurality of inventory offerings, and wherein the processor is further configured to receive input selecting an inventory offering from the plurality of inventory offerings for association with a travel itinerary of the plurality of travel itineraries.

5. The system of claim 4, wherein each of the inventory offerings is associated with one or more traveller types of the plurality of traveller types.

6. The system of claim 5, wherein the one or more traveller types associated with the inventory offerings are available to be accessed prior to the processor receiving input for selecting an inventory offering to be associated with a travel itinerary.

7. The system of claim 5, wherein a number of inventory offerings are selected to be associated with a given travel itinerary, and the at least one traveller type associated with the given travel itinerary is determined from the traveller types associated with the number of inventory offerings.

8. The system of claim 5, wherein the at least one traveller type associated with a given travel itinerary is pre-determined, and only a subset of the plurality of inventory offerings, each of which is associated with the pre-determined at least one traveller type, are available to be selected for association with the given travel itinerary.

9. The system of claim 1, wherein the associations between the plurality of images and their respective traveller types are pre-determined and loaded into the one or more databases.

10. The system of claim 1, wherein the associations between the plurality of images and their respective traveller types are generated from an electronic survey.

11. The system of claim 10, wherein the processor is further configured to conduct the electronic survey by:
making available for display an uncategorized image that has not been associated with any traveller type;
providing one or more of the plurality of traveller types as options to be selected to be associated with the uncategorized image;
receiving input selecting a traveller type of the one or more of the plurality of traveller types as being associated with the uncategorized image; and
storing an association between the selected traveller type and the uncategorized image in the one or more databases.

12. The system of claim 1, wherein the processor is further configured to:
receive input, from a first traveller device, selecting one itinerary of the subset of the plurality of itineraries, the one itinerary comprising a plurality of inventory offerings that are each associated with a geographical location;
in response to the received input selecting the one itinerary, provide an itinerary identifier for identifying the selected itinerary, wherein the itinerary identifier is transmittable to a second traveller device;
receive input, from the second traveller device, comprising the itinerary identifier for the selected itinerary and a request to modify an inventory offering of the selected itinerary; and
provide an alternate inventory offering for the inventory offering requested to be modified, the alternate inventory offering being associated with the geographical location of the activity requested to be modified.

13. The system of claim 12, wherein the processor is further configured to receive input from the second traveller device selecting the alternate inventory offering, and create a new itinerary comprising the alternate inventory offering and the plurality of inventory offerings associated with the one selected itinerary except the inventory offering requested to be modified.

14. The system of claim 12, wherein the processor is further configured to receive input from the second traveller device selecting the alternate inventory offering, and create a new itinerary comprising the alternate inventory offering and a link to the one selected itinerary.

15. A method of identifying travel itineraries at a server, the method comprising:
identifying a plurality of images stored in one or more databases, wherein each of the plurality of images is associated with at least one of a plurality of traveller types;
identifying a subset of the plurality of images;
receiving input selecting an image of the subset of images;
determining, from the one or more databases, the at least one traveller type associated with the selected image;
identifying, from the one or more databases storing a plurality of travel itineraries, each of which is associated with at least one of the plurality of traveller types, a subset of the plurality of travel itineraries that are associated with the determined at least one traveller type; and
providing the subset of the plurality of travel itineraries, in response to the received input selecting the one image of the subset of images.

16. The method of claim 15, wherein the plurality of traveller types corresponds to psychographic classifications.

17. The method of claim 16, wherein the psychographic classifications comprise Explorer Quotient™ profile types.

18. The method of claim 15, comprising the step of receiving input selecting an inventory offering from a plurality of the inventory offerings stored on the one or more databases for association with a travel itinerary of the plurality of travel itineraries.

19. The method of claim 18, wherein the inventory offerings are each associated with one or more traveller types of the plurality of traveller types.

20. The method of claim 19, wherein the one or more traveller types associated with the inventory offerings are available to be accessed prior to the step of receiving input for selecting an inventory offering to be associated with a travel itinerary.

21. The method of claim 19, wherein a number of inventory offerings are selected to be associated with a given travel itinerary, and the at least one traveller type associated with the given travel itinerary is determined from the traveller types associated with the number of inventory offerings.

22. The method of claim 19, wherein the at least one traveller type associated with a given travel itinerary is pre-determined, and only a subset of the plurality of inventory offerings that are associated with the pre-determined at least one traveller type are available to be selected for association with the given travel itinerary.

23. The method of claim 15, wherein the associations between the plurality of images and their respective traveller types are pre-determined and loaded into the one or more databases.

24. The method of claim 15, wherein the associations between the plurality of images and their respective traveller types is generated from an electronic survey.

25. The method of claim 24, comprising the step of conducting the electronic survey by:
making available for display an uncategorized image that has not been associated with any traveller type;
providing one or more of the plurality of traveller types as options to be selected to be associated with the uncategorized image;
receiving input selecting a traveller type of the one or more of the plurality of traveller types as being associated with the uncategorized image; and
storing an association between the selected traveller type and the uncategorized image in the one or more databases.

26. The method of claim 15, comprising:
receiving input, from a first traveller device, selecting one itinerary of the subset of the plurality of itineraries, the one itinerary comprising a plurality of inventory offerings that are each associated with a geographical location;
in response to the received input selecting the one itinerary, providing an itinerary identifier for identifying the selected itinerary, wherein the itinerary identifier is transmittable to a second traveller device;
receiving input, from the second traveller device, comprising the itinerary identifier for the selected itinerary and a request to modify an inventory offering of the selected itinerary; and
providing an alternate inventory offering for the inventory offering requested to be modified, the alternate inventory offering being associated with the geographical location of the activity requested to be modified.

27. The method of claim 26, comprising receiving input from the second traveller device selecting the alternate inventory offering, and creating a new itinerary comprising the alternate inventory offering and the plurality of inventory offerings associated with the one selected itinerary except the inventory offering requested to be modified.

28. The method of claim 26, comprising receiving input from the second traveller device selecting the alternate inventory offering, and creating a new itinerary comprising the alternate inventory offering and a link to the one selected itinerary.
